(19) United States
(12) Patent Application Publication
(10) Pub. No.: US 2022/0126491 A1
(43) Pub. Date: Apr. 28, 2022

(54) METHOD FOR MANUFACTURING AN OPTICAL LENS

(71) Applicants: Cheng-Ho CHEN, Changhua County (TW); Chih-Tsung KUO, Taichung City (TW)

(72) Inventors: Chih-Tsung KUO, Taichung City (TW); Chuen-Cherng YANG, Taichung City (TW)

(21) Appl. No.: 17/509,819

(22) Filed: Oct. 25, 2021

(30) Foreign Application Priority Data
Oct. 26, 2020 (TW) 109137136

(51) Int. Cl. B29C 45/00; B29D 11/00

(52) U.S. Cl. CPC B29C 45/0003; B29D 11/0048

(57) ABSTRACT

A method for manufacturing an optical lens includes pressing a fluid-state optical material by using a solid-state optical material to inject the fluid-state optical material molten from the solid-state optical material into a cavity. The solid-state optical material is molten only at the part adjacent to the cavity to form the fluid-state optical material, which facilitates transport of the optical material and minimizes residual waste. The pressing force applied to the solid-state optical material can be controlled to hence control the moving rate of the solid-state optical material, thereby precisely controlling the injection volume and injection rate of the fluid-state optical material.

### CROSS-REFERENCE TO RELATED APPLICATION

This application claims priority of Taiwanese Patent Application No. 109137136, filed on Oct.26, 2020.

### FIELD

The disclosure relates to a method for manufacturing an optical lens, and more particularly to an injection molding method for manufacturing an optical lens from a plastic or glass material.

### BACKGROUND

Optical lenses are conventionally made of glass and involve molding technology. In the manufacturing process, multiple processes such as pre-shaping and polishing are required, which are complicated and result in high manufacturing costs. Therefore, some optical lenses are produced by injection molding method using a plastic raw material. In such manufacturing process, granular plastic raw materials are heated and molten in a material barrel, and are pressed forward by a feeding screwed rod so as to inject the molten raw materials in a cavity of a mold to fill the same. After completion of injection and filling, the mold and the plastic raw materials in the mold are cooled to solidify and shrink the plastic raw materials in a compressed state, whereby an optical lens is molded.

During the pressed movement of the molten raw materials, a fluid conduit for transmitting the molten fluid material has various inner dimensions to keep a stable transmission of the fluid material and to contribute the fluid material to multiple subconduits for producing a plurality of optical lens products.

Specifically, referring to FIG. 1, a conventional molding device 91 has a wider primary conduit 911 and a plurality of narrower subconduits 912 to which the primary conduit 911 branches off. Due to a variety of flowing directions of the primary conduit 911 and the subconduits 912, a plurality of turning corners are formed in the conduits, which results in pressure loss therein. Since multiple and long distanced conduits for optical raw materials of relatively high viscosity in the molten state will cause more pressure loss and uneven pressure distribution therein, a relatively high load is required for the injection molding machine to press and feed the raw materials, and uneven pressure distribution in the conduits results in difficulty to form precise optical products and leads to material waste. In addition, part of the optical material remaining in the conduits after the cooling process will become waste and cannot be reused (this is because the material undergoes qualitative change and stress-induced crystallization after the initial heating process), which results in waste of material and production costs. Specifically, a cooled solid-state blank material 92 obtained is shown in FIG. 2, which includes finished parts 922 and waste parts 921 which should be removed from the finished parts 922 to obtain optical products.

Moreover, in an injection molding process, a predetermined holding pressure is set and utilized as a control parameter to control the injection volume of raw materials. The injection volume cannot be adjusted precisely for different numbers and sizes of mold cavities. Besides, the flow conduits in the injection molding machine for injecting raw materials into mold cavities to fill the same affect the holding pressure and the required injection volume. The conduits may have various primary conduits and branching subconduits. These factors make it troublesome to precisely control the amount of injection into the mold cavities, which affects the quality of the optical lens products.

### SUMMARY

Therefore, an object of the disclosure is to provide a method for manufacturing an optical lens that can alleviate at least one of the drawbacks of the prior art.

According to the disclosure, the manufacturing method includes: (A) providing an optical lens molding device, the optical lens molding device including a molding unit, a raw material supplying unit for providing a solid-state optical material, a feeding unit disposed downstream of the raw material supplying unit in a feeding direction for transporting the solid-state optical material along the feeding direction, a heating unit disposed downstream of the feeding unit in the feeding direction, and a cooling unit disposed between the heating unit and the feeding unit in the feeding direction. The heating unit includes a heating body which defines a heating chamber therein, a heating conduit which is in spatial communication with the raw material supplying unit for entering of the solid-state optical material, and which has a downstream part that extends in the heating chamber so as to heat and melt the solid-state optical material in the heating conduit into the fluid-state optical material, and a heating tube which projects outwardly of the heating chamber. The molding unit includes at least two molds which cooperatively define a cavity therebetween, and a sprue which is in communication between the cavity and the downstream part. The cooling unit includes a heat dissipating fin assembly which surrounds the heating tube, and at least one heat dissipating fan which is disposed on the heat dissipating fin assembly; and (B) heating the solid-state optical material in the heating conduit by the heating unit to heat and melt a forward part of the solid-state optical material adjacent to the cavity into a fluid-state optical material; and (C) pressing the fluid-state optical material by using the solid-state optical material to inject the fluid-state optical material molten from the solid-state optical material (S) into the cavity.

The solid-state optical material is molten only at the part adjacent to the cavity to form the fluid-state optical material, which facilitates transport of the optical material and minimizes residual waste. The pressing force applied to the solid-state optical material can be controlled to hence control the moving rate of the solid-state optical material, thereby precisely controlling the injection volume and injection rate of the fluid-state optical material.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a conventional molding device;

FIG. 2 is a perspective view of a solid blank material;

FIG. 3 is a flow diagram illustrating the steps in an embodiment of a method for manufacturing an optical lens according to the disclosure; FIG. 4 is a perspective view illustrating an optical lens molding device for conducting the steps of the method;

FIG. 5 is a fragmentary perspective view of FIG. 4;

FIG. 6 is a fragmentary top view illustrating a raw material supplying unit, a cooling unit, a heating unit and a lower fixed mold of the optical lens molding device;

FIG. 7 is a sectional view taken along line VII-VII of FIG. 6, illustrating that an upper movable mold is in an opened state and an eject rod is in a retreated position;

FIG. 8 is a sectional view similar to FIG. 7, illustrating that the upper movable mold is in a closed state and the eject rod is in the retreated position;

FIG. 9 is a fragmentary enlarged view of FIG. 8; and

FIG. 10 is a sectional view similar to FIG. 7, illustrating that the upper movable mold is in the opened state and the eject rod is in an ejecting position.

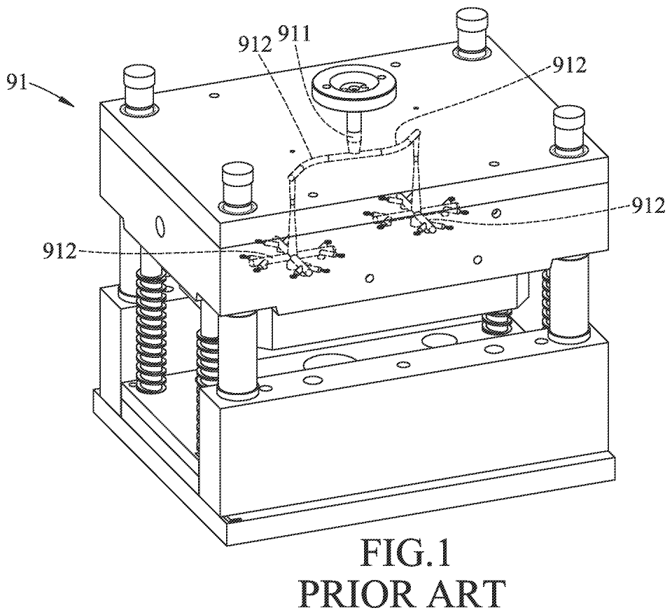

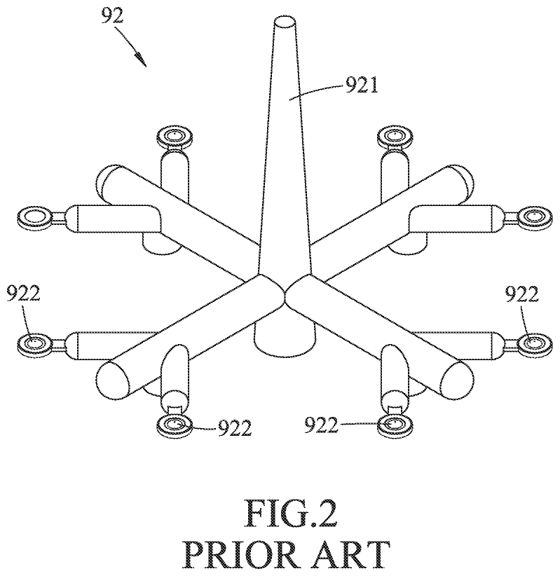

### DETAILED DESCRIPTION

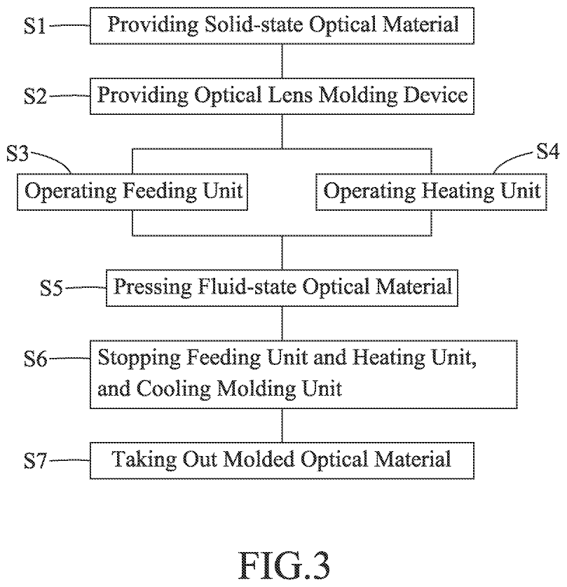

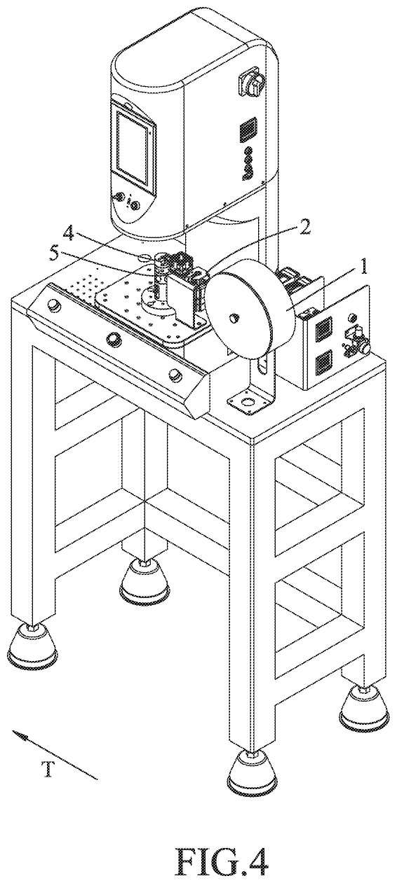

Referring to FIG. 3, an embodiment of a method for manufacturing an optical lens according to the disclosure includes the following steps.

In step S1, a solid-state optical material (S) is provided. The solid-state optical material (S) is linear or rod-shaped, and may be plastic, glass or other material suitable for forming a lens.

In step S2, an optical lens molding device is provided.

With reference to FIGS. 4, 5 and 6, the optical lens molding device includes a raw material supplying unit 1, a feeding unit 2, a heating unit 3, a molding unit 4 and a cooling unit 5. The raw material supplying unit 1, the feeding unit 2, the heating unit 3 and the molding unit 4 are arranged along a feeding direction (T). The cooling unit 5 is disposed between the heating unit 3 and the feeding unit 2 in the feeding direction (T).

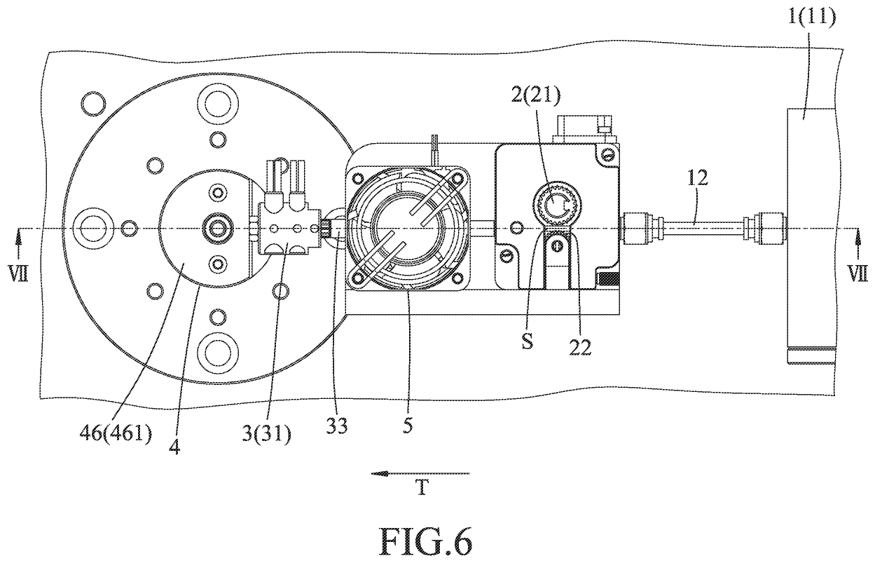

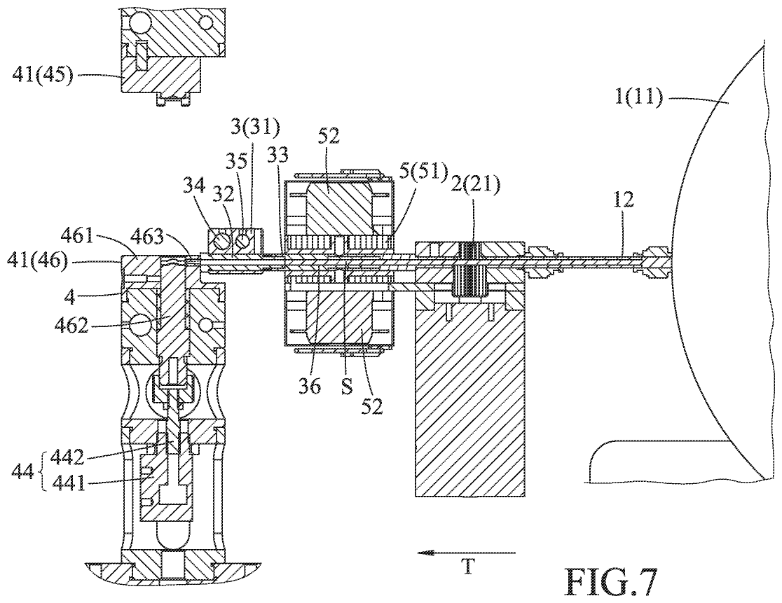

With reference to FIGS. 6 and 7, the raw material supplying unit 1 is disposed for providing a solid-state optical material (S), and includes a raw material storage module 11 for storing the solid-state optical material (S), and a feeding tube 12 which is connected with the raw material storage module 11 and which extends in the feeding direction (T) to be disposed upstream of the feeding unit 2.

The feeding unit 2 is disposed downstream of the raw material supplying unit 1 in the feeding direction (T) for transporting the solid-state optical material (S) along the feeding direction (T). The feeding unit 2 includes a first feeding roller 21 and a second feeding roller 22 which cooperatively define therebetween a feeding path that extends in the feeding direction (T) for transmitting the solid-state optical material (S) from the raw material supplying unit 1 along the feeding path. In this embodiment, the first feeding roller 21 is operative to make a rolling movement so as to move the solid-state optical material (S) forward along the feeding path and to make a synchronous rolling movement of the second feeding roller 22. Alternatively, both the first and second feeding rollers 21, 22 may be operative to roll synchronously and in opposite rotational directions.

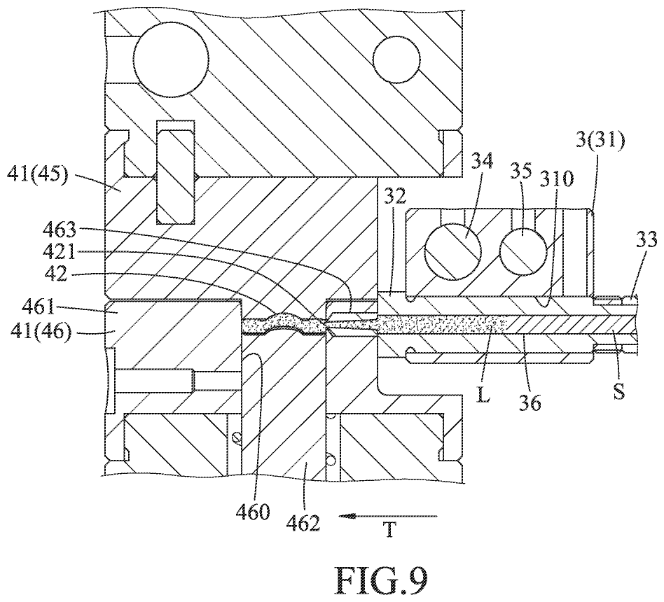

The heating unit 3 includes a heating body 31 which defines a heating chamber 310 therein (see FIG. 9), a heat source 34 which is embedded in the heating body 31, and a temperature sensor 35 which is disposed adjacent to the heat source 34. The heating unit 3 further includes a heating conduit 36 which is in spatial communication with the raw material supplying unit 1 for entering of the solid-state optical material (S). Specifically, the heating conduit 36 has a nozzle 32 which serves as a downstream part thereof and is disposed in the heating chamber 310 of the heating body 31, and a heating tube 33 which extends in the feeding direction (T) and projects outwardly of the heating chamber 310 to be connected between the nozzle 32 and the raw material storage module 11.

In this embodiment, the heating tube 33 is not extended in the heating chamber 310 of the heating body 31 such that the juncture between the heating tube 33 and the nozzle 32 is disposed outwardly of the heating body 31. Alternatively, part of the heating tube 33 may be extended in the heating chamber 310 such that the juncture is disposed in the heating body 31.

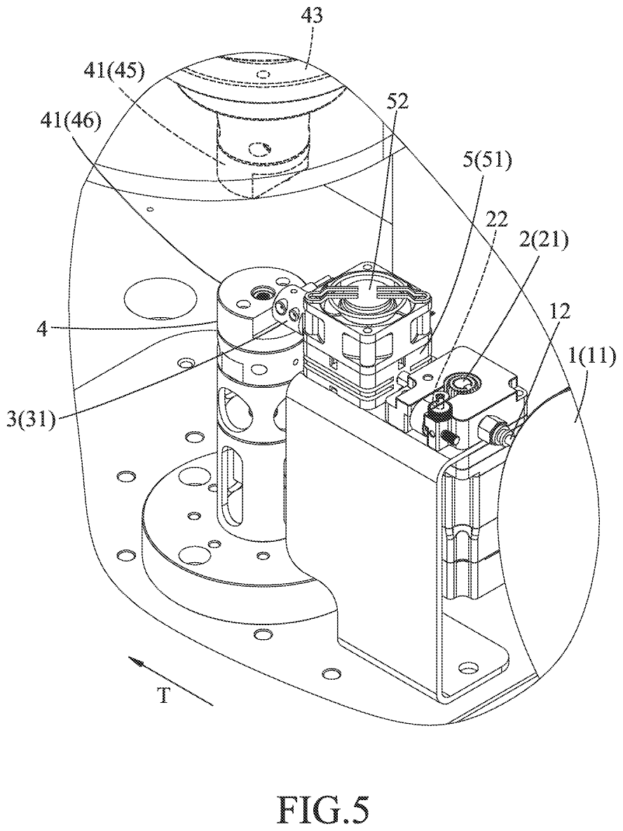

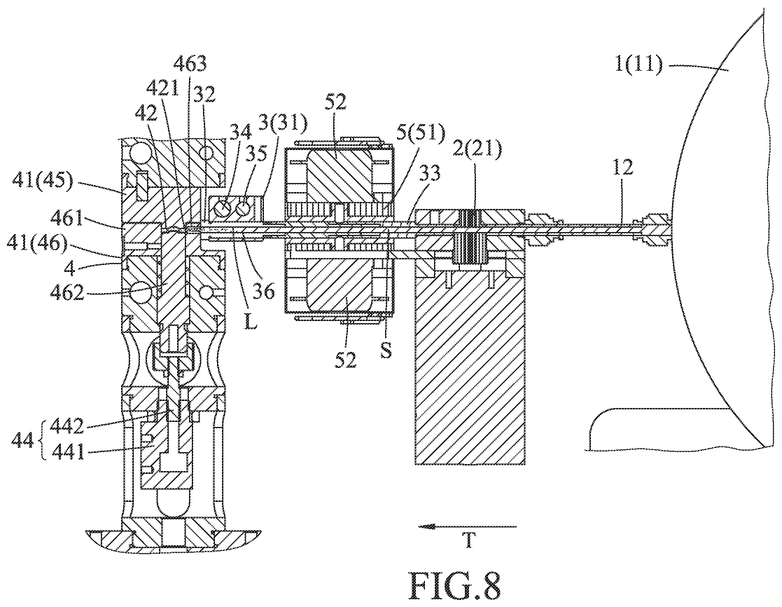

The molding unit 4 includes two molds 41 matingly engageable with each other in an up-down direction transverse to the feeding direction (T), a first driving module 43 (referring to FIG. 5) and a second driving module 44 (referring to FIG. 7). In this embodiment, the molding unit 4 includes an upper movable mold 45 and a lower fixed mold 46 which respectively have mold surfaces cooperatively defining a cavity 42 (referring to FIGS. 8 and 9) therebetween. The lower fixed mold 46 has a surrounding mold body 461 having a central hole 460 (referring to FIG. 9), and an eject rod 462 inserted into and movable in the central hole 460 in the up-down direction. The lower fixed mold 46 is formed with a passage 463 for insertion of the nozzle 32 and extending through the lower fixed mold 46 to terminate at a sprue 421 to be in spatial communication with the cavity 42 through the sprue 421.

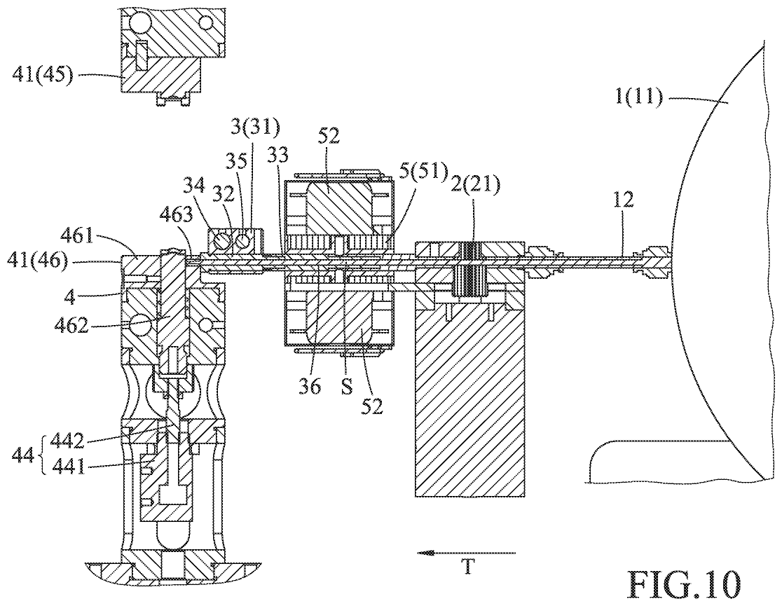

The first driving module 43 is disposed to drive movement of the upper movable mold 45 in the up-down direction relative to the lower fixed mold 46 between an opened state (as shown in FIGS. 7 and 10), where the upper movable mold 45 is remote from the lower fixed mold 46, and a closed state (as shown in FIGS. 8 and 9), where the upper movable mold 45 abuts against the lower fixed mold 46 to define the cavity 42 bordered by the mold surfaces.

The second driving module 44 is disposed to drive movement of the eject rod 462 in the up-down direction such that the eject rod 462 is movable relative to the surrounding mold body 461 between a retreated position (as shown in FIGS. 7, 8 and 9) and an ejecting position (as shown in FIG. 10).

It should be noted that the molding unit 4 has two molds 41 in this embodiment, and may have more than two molds 41 as required.

In this embodiment, the second driving module 44 has a cylinder 441 and a press rod 442 which is slidably inserted into the cylinder 441 and has an upper end connected with a lower end of the eject rod 462. The cylinder 441 may be a hydraulically or pneumatically controlled cylinder so as to drive the movement of the eject rod 462 in the up-down direction.

The cooling unit 5 is interposed between the heating unit 3 and the feeding unit 2, and includes a heat dissipating fin assembly 51 which surrounds the heating tube 33, and at least one heat dissipating fan 52 which is disposed on the heat dissipating fin assembly 51. In this embodiment, two of the heat dissipating fans 52 are mounted on upper and lower sides of the heat dissipating fin assembly 51.

In step S3, the feeding unit 2 is operated to feed the solid-state optical material (S) from the raw material supplying unit 1 to the heating tube 33 of the heating unit 3.

In step S4, the heating unit 3 is operated to heat the solid-state optical material (S) in the heating tube 33 by the heat source 34. When the solid-state optical material (S) in the heating tube 33 is heated by the heating unit 3, a forward part of the solid-state optical material (S) adjacent to the cavity 42 is molten into a fluid-state optical material (L), as shown in FIG. 9.

It should be noted that, when the eject rod 462 is in the retreated position (as shown in FIGS. 7 to 9), the upper end of the eject rod 462 is retreated in the central hole 460 so as not to interfere with injection of the fluid-state optical material (L) into the cavity (i.e. filling of the cavity 42) through the sprue 421. The eject rod 462 is moved upwardly relative to the mold body 461 a predetermined distance to the ejecting position.

Additionally, with the cooling unit 5 disposed around the heating tube 33, formation of the molten optical material due to its heat conductivity at the upstream part of the heating conduit 36 is avoided. In other words, a heat generated from the heat source 34 is conducted downstream to heat and melt the solid-state optical material (S) into the fluid-state optical material (L) at the downstream part of the heating conduit 36 while a heat generated from the heat source 34 and conducted upstream is dissipated by the cooling unit 5 so as not to soften and melt the solid-state optical material (S) at the upstream part of the heating conduit 36.

Also, in this embodiment, the heating conduit 36 has a gradually narrower part in vicinity of the sprue 421, and the inner diameter of the sprue 421 is smaller than a thickness of the solid-state optical material (S). The pressure applied to the fluid-state optical material (L) is gradually increased during the movement of the fluid-state optical material (L) toward the sprue 421 so as to facilitate injection of the optical material into the cavity 42 from the sprue 421.

In addition, the temperature sensor 35 senses the heat energy of the heat source 34 so as to control the heat source 34 to perform heating and melting of the solid-state optical material (S) with a predetermined temperature.

In step S5, during the operation of the feeding unit and the heating unit 3, the solid-state optical material (S) is transmitted by the feeding unit 2 and gives a forward pushing force to the molten fluid-state optical material (L) such that the molten fluid-state optical material (L) is smoothly injected in and fills the cavity 42 through the sprue 421.

It should be noted that, in this embodiment, the upper movable mold 45 is in the opened state and the eject rod 462 is in the retreated position (as shown in FIG. 7) when the molding unit 4 is in a ready state. During the operation of the molding unit 4, the upper movable mold 45 is moved to the closed state so as to form the cavity 42 while the eject rod 462 is kept in the retreated position so as to conduct step S5.

In this embodiment, step S3 is conducted to operate the molding device in a state as shown in FIG. 5, and then steps S4 and S5 are conducted to bring the molding device into a state as shown in FIG. 8. Alternatively, steps S3 and S4 may be conducted in this sequence, at the same time, alternately, or repeatedly. The molding device may be operated manually or in an automatically controlled manner.

In step S6, the feeding unit 2 and the heating unit 3 are stopped, and the molding unit 4 is cooled such that the fluid-state optical material (L) in the cavity 42 is solidified.

In step S7, after the fluid-state optical material (L) is solidified, the upper movable mold 45 is moved to the opened state to open the cavity 42. Then, the second driving module 44 is operated to move the eject rod 462 to the ejecting position to take out a molded optical lens in the cavity 42 (as shown in FIG. 10). It should be noted that in the ejecting position, the eject rod 462 is disposed to block the sprue 421 so as to prevent flowing out of the fluid-state optical material (L) from the heating conduit 36. Furthermore, at this stage, the feeding unit 2 is temporally stopped for feeding the solid-state optical material (S) to prevent overload of the feeding unit 2.

Therefore, in this embodiment, the fluid-state optical material (L) is pressed by the solid-state optical material (S) which is fed in a stable manner so as to render the transmission and feeding of the optical material stable and avoid overload of the molding machine. Specifically, with the first and second feeding rollers 21, 22 making rolling movements and defining a feeding path therebetween to move the solid-state optical material (S) forward, the feeding of the solid-state optical material is relatively smooth and stable as compared with a conventional spiral impeller driving a fluid-state optical material and can be operated without taking the viscosity of the optical material into account, and the feeding load of the feeding unit 2 is decreased.

Moreover, in this embodiment, the heating conduit 36 is a straight linear passage such that pressure loss of the fluid-state optical material (L) during flowing is minimized so as to decrease the load required to apply to the solid-state optical material (S). Also, the fluid-state optical material (L) is directly injected and flows into the cavity 42 through the sprue 421 without the need to flow through extra, numerous and long conduits so as to decrease load of the molding machine and minimize waste. Specifically, the fluid-state optical material (L) is gradually cooled when it is moved away from the heat source 34 and forwards to the sprue 421. After the injection molding process has been completed, the feeding unit 2 can be operated to transmit the solid-state optical material (S) in a reverse direction such that the fluid-state optical material (L) around the sprue 421 can be withdrawn back and prevented from being solidified. Thus, the optical material remaining in the heating conduit 36 can be again pressed toward the heat source 34 and the sprue 421 so as to minimize material waste. Moreover, the heat source 34 may be kept in a turn-on state for maintaining a predetermined temperature of the fluid-state optical material (L), which facilitates continuous production.

In this embodiment, the solid-state optical material (S) is linear or rod-shaped and is adapted to enter directly into the heating conduit 36 so as to be fed one by one in the feeding direction (T). As compared with the conventional injection molding process in which an optical raw material is fed in batches and a drying process is required, the molding device used in this embodiment is easier to be used in continuous and mass production.

Furthermore, in this embodiment, the inner diameter of the sprue 421 is smaller than the thickness of the solid-state optical material (S). Thus, the optical material that is injected from the sprue 421 is of a fluid state so as to be injected into the cavity 42 with a precise controlled pressure. Specifically, the solid-state optical material (S) serves as a piston rod, and a pressing force which presses the solid-state optical material (S) corresponds directly with the injecting pressure applied to the fluid-state optical material (L) through the sprue 421. As compared with a conventional feeding technique, there is no spiral impeller or other structures disposed in the heating conduit 36 in this embodiment, and the injecting pressure through the sprue 421 can be easily controlled so as to precisely inject the predetermined amount of an optical material.

Also, in operation, the moving rate of the solid-state optical material (S) in the feeding process can be controlled in accordance with the pressing force of the feeding unit 2 applied to the solid-state optical material (S). Rather than controlling the holding pressure to determine the required injection volume and injection rate in the conventional molding technique, the required injection volume and injection rate of the optical material can be determined based on the fed length of the solid-state optical material (S) which is linear or rod-shaped in this embodiment, which renders the control of the injection volume and rate more precisely.

As illustrated, with the method of the disclosure, the solid-state optical material (S) is molten only at the part adjacent to the cavity 42 to form the fluid-state optical material (L). At the same time, a pressing force applied to the solid-state optical material (S) by the feeding unit 2 can be transmitted to press the fluid-state optical material (L). Also, no subconduits are required to be formed in the molds so as to minimize residual waste therein. The pressing force applied to the solid-state optical material (S) by the feeding unit 2 can be controlled to hence control the moving rate of the solid-state optical material (S), thereby precisely controlling the injection volume and injection rate of the fluid-state optical material (L).

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for manufacturing an optical lens, comprising:
(A) providing an optical lens molding device, the optical lens molding device including a molding unit, a raw material supplying unit for providing a solid-state optical material, a feeding unit disposed downstream of the raw material supplying unit in a feeding direction for transporting the solid-state optical material along the feeding direction, a heating unit disposed downstream of the feeding unit in the feeding direction, and a cooling unit disposed between the heating unit and the feeding unit in the feeding direction, the heating unit including a heating body which defines a heating chamber therein, a heating conduit which is in spatial communication with the raw material supplying unit for entering of the solid-state optical material, and which has a downstream part that extends in the heating chamber so as to heat and melt the solid-state optical material in the heating conduit into the fluid-state optical material, and a heating tube which projects outwardly of the heating chamber, the molding unit including at least two molds which cooperatively define a cavity therebetween, and a sprue which is in communication between the cavity and the downstream part, the cooling unit including a heat dissipating fin assembly which surrounds the heating tube, and at least one heat dissipating fan which is disposed on the heat dissipating fin assembly;
(B) heating the solid-state optical material in the heating conduit by the heating unit to heat and melt a forward part of the solid-state optical material adjacent to the cavity into a fluid-state optical material; and
(C) pressing the fluid-state optical material by using the solid-state optical material to inject the fluid-state optical material molten from the solid-state optical material into the cavity.

2. The method as claimed in claim 1, further comprising:
(D) providing the solid-state optical material.

3. The method as claimed in claim 2, wherein the solid-state optical material provided in step (D) is linear or rod-shaped.

4. The method as claimed in claim 1, further comprising :
(E) operating the feeding unit to feed the solid-state optical material from the raw material supplying unit to the heating conduit of the heating unit.

5. The method as claimed in claim 1, further comprising:
(F) cooling the molding unit such that the fluid-state optical material in the cavity is solidified.

6. The method as claimed in claim 1, wherein, in step (C), a part of the solid-state optical material that is not molten is pressed by the feeding unit to permit the molten fluid-state optical material to be pressed by the solid-state optical material and to flow in and fill the cavity through the sprue.

7. The method as claimed in claim 1, wherein in step (A), the molding unit includes an upper movable mold and a lower fixed mold which serve as the at least two molds, the lower fixed mold being formed with a passage for insertion of the downstream part of the heating conduit and extending through the lower fixed mold to terminate at the sprue to be in spatial communication with the cavity through the sprue.

8. The method as claimed in claim 7, wherein, in step (A), the molding unit further includes a first driving module which is disposed to drive movement of the upper movable mold relative to the lower fixed mold between an opened state where the upper movable mold is remote from the lower fixed mold, and a closed state where the upper movable mold abuts against the lower fixed mold to define the cavity.

9. The method as claimed in claim 8, wherein, in step (A), the lower fixed mold of the molding unit has a surrounding mold body having a central hole, and an eject rod inserted into and movable in the central hole in an up-down direction, the passage extending through the surrounding mold body, the eject rod having an upper end which is movable relative to the surrounding mold body between a retreated position, where the upper end is retreated in the central hole, and an ejecting position, where the upper end ejects upwardly of the central hole to take out a molded optical lens in the cavity, and the eject rod blocks the sprue.

10. The method as claimed in claim 9, further comprising:
(G) moving the upper movable mold from the closed state to the opened state to open the cavity, and operating a second driving module to move the eject rod from the retreated position to the ejecting position.
